(19) United States
(12) Patent Application Publication
(10) Pub. No.: US 2024/0245576 A1
(43) Pub. Date: Jul. 25, 2024

(54) VIBRATOR DEVICE FOR MASSAGE ASSEMBLY

(71) Applicants: Chris Marshall, Ramona, CA (US); Jerry Tu, Diamond Bar, CA (US)

(72) Inventors: Chris Marshall, Ramona, CA (US); Jerry Tu, Diamond Bar, CA (US)

(73) Assignee: IFA Engineered Components Group, Inc, Diamond Bar, CA (US)

(21) Appl. No.: 18/100,749

(22) Filed: Jan. 24, 2023

(51) Int. Cl. A61H 23/02; A61H 15/00

(52) U.S. Cl. CPC A61H 23/0263; A61H 15/0078; A61H 2015/0014; A61H 2015/0042; A61H 2015/0071; A61H 2023/0281; A61H 2201/0157; A61H 2201/1215; A61H 2201/1654; A61H 2201/5005; A61H 2201/5023; A61H 2205/081; A61H 2205/12

(57) ABSTRACT

A vibrator device for a massage assembly is disclosed. The vibrator device comprises a housing, at least one motor disposed in the housing and a shaft extending from the motor positioned within the housing. The shaft comprises one or more weights. The vibrator device further comprises a power source positioned within the housing. The power source comprises a battery assembly. The battery assembly is electrically connected to the motor to supply power to the motor. The motor is configured to induce vibratory amplitude to vibrate the massage assembly. The massage assembly has a foam body with a cavity to receive the vibrator device within the cavity. The foam body have different shapes and the vibrator device positioned within the cavity of the foam body provides an effective and safe therapeutic massage experience to the user.

### BACKGROUND OF THE INNOVATION

### A. Technical Field

The present invention generally relates to a vibrator device, and, more particularly, to a vibrator device for a massage assembly.

### B. Description of Related Art

Massage devices are common personal care products used to provide muscle relief for consumers. The massage practice could provide therapeutic advantages such as alleviate pain, stimulate circulation, relieve tension, provide flexibility to muscles and joints, and improve range of motion. Additionally, the massage practice could provide psychological benefits such as lessening depression and anxiety and increasing sleep quality.

A handheld massaging device is one of the massaging devices preferred by consumers. Generally, the handheld massage device includes a massage head and an electric motor to impart vibration on the massage head. The existing massage devices have very complicated structure and are thus expensive in cost, easy to damage and hard to repair and maintain. Further, each type of handheld massage device requires a suitable type of electric motor, which need to be plugged in to power supply for operating the massaging device.

Few existing patent references attempted to address the aforementioned problems are cited in the background as prior art over the presently disclosed subject matter and are explained as follows.

A prior art U.S. Ser. No. 10/449,112 assigned to Godfrey Brian P., entitled “vibrating massage roller” discloses a massage roller and a method for balancing the massage roller. The massage roller comprises a motor, a battery pack electrically coupled to the motor and a control unit having multiple switches to alter the vibrational characteristics by adjusting the rotational characteristics of the motor.

Another prior art WO2020174242 assigned to Tremayne GILLING., entitled “massage device” discloses a massage device comprising a heating element for heating the device, and a vibrating mechanism for vibrating the device. The device further comprises an electronic circuitry to control the operation of the device and at least one battery to supply power for the operation of the device.

However, the existing prior arts has a complicated design and lacks to provide a configuration that could effectively use existing designs of massage device.

Therefore, there is a need for a device that could effectively use existing massage rollers and massage devices. Further, there is a need for a device having a configuration that requires simple and convenient installation steps to use with different massage devices and rollers for effectively massaging any desired part of the user's body.

### SUMMARY OF THE INNOVATION

The present invention discloses a vibrator device for a massage assembly. The vibrator device is configured to use with the massage assembly selected from a group, including, but not limited to small massage rollers, foam balls, lumbar and foot massagers, and peanut massage roller. The vibrator device comprises a housing, at least one motor disposed in the housing and a shaft extending from the motor positioned within the housing. The shaft comprises one or more weights. The housing comprises at least two sections. The two sections are joined together via one or more fasteners. The vibrator device further comprises a power source positioned within the housing. In one embodiment, the power source comprises a battery assembly having a lithium polymer battery. The battery assembly is electrically connected to the motor to supply power to the motor. The motor is configured to induce vibratory amplitude to vibrate the massage assembly. The motor is configured to operate at different speeds with respective to different frequencies.

The device further comprises at least one switch configured to enable a user to turn on and turn off the vibrator device. The device further comprises a USB port configured to enable the user to recharge the battery assembly. The massage assembly includes at least one of a massage roller, a foam roller, a massage foam ball, a lumbar, a foot foam massager, and a peanut foam roller. The device further comprises a level indicator configured to display a power level of the battery and a speed of the vibrator device. In one embodiment, the level indicator is further configured to display the speed of the motor. The vibrator device is securely positioned within the massage assembly. The massage assembly is selected from a group, including, but not limited to small massage rollers, foam balls, lumbar and foot massagers, and peanut massage roller.

The present invention further discloses a massage assembly. The massage assembly comprises a body having a cavity and an opening to access the cavity. The body is made of foam material. The body further comprises a sleeve fixed within the cavity. The sleeve is shaped to contour the shape of the cavity. The vibratory device is received over the sleeve provided within the cavity of the massage assembly. The vibrator device is received within the cavity and mechanically coupled to the massage assembly. The vibrator device is configured to induce vibratory amplitude to vibrate the massage assembly, which provides an effective and safe therapeutic massage experience to the user. The massage assembly with the vibrator device enhances therapeutic advantages, alleviate pain, stimulate circulation, relieve tension, provide flexibility to muscles and joints, and also improve range of motion.

Other objects, features and advantages of the present innovation will become apparent from the following detailed description. It should be understood, however, that the detailed description and the specific examples, while indicating specific embodiments of the innovation, are given by way of illustration only, since various changes and modifications within the spirit and scope of the innovation will become apparent to those skilled in the art from this detailed description.

### BRIEF DESCRIPTION OF DRAWINGS

The foregoing summary, as well as the following detailed description of the innovation, is better understood when read in conjunction with the appended drawings. For the purpose of illustrating the innovation, exemplary constructions of the innovation are shown in the drawings. However, the innovation is not limited to the specific methods and structures disclosed herein. The description of a method step or a structure referenced by a numeral in a drawing is applicable to the description of that method step or structure shown by that same numeral in any subsequent drawing herein.

FIG. 1 illustrates a perspective view of a vibrator device for a massage assembly, in an embodiment of the present invention.

FIG. 2 illustrates a perspective view of the vibrator device having a power source and a motor, in an embodiment of the present invention.

FIG. 3 illustrates a sectional view of the vibrator device securely positioned within a foam roller, in an embodiment of the present invention.

FIG. 4 illustrates a perspective view of the vibrator device securely positioned within the foam roller of FIG. 3.

FIG. 5 illustrates a perspective view of the vibrator device securely positioned within a massage foam ball, in one embodiment of the present invention.

FIG. 6 illustrates a sectional view of the vibrator device securely positioned within the massage foam ball of FIG. 5.

FIG. 7 illustrates a perspective view of a lumbar and foot foam massager provided with the vibrator device, in one embodiment of the present invention.

FIG. 8 illustrates a side view of the lumbar and foot foam massager of FIG. 7 provided with the vibrator device.

FIG. 9 illustrates a bottom perspective view of the lumbar and foot foam massager of FIG. 7 provided with the vibrator device.

FIG. 10 illustrates a bottom view of the lumbar and foot foam massager of FIG. 7 provided with the vibrator device.

FIG. 11 illustrates a perspective view of a peanut foam massager or roller provided with the vibrator device, in one embodiment of the present invention.

FIG. 12 illustrates a bottom perspective view of the peanut foam massager or roller of FIG. 11 provided with the vibrator device.

### DETAILED DESCRIPTION OF EMBODIMENTS

A description of embodiments of the present innovation will now be given with reference to the Figures. It is expected that the present innovation may be embodied in other specific forms without departing from its spirit or essential characteristics. The described embodiments are to be considered in all respects only as illustrative and not restrictive.

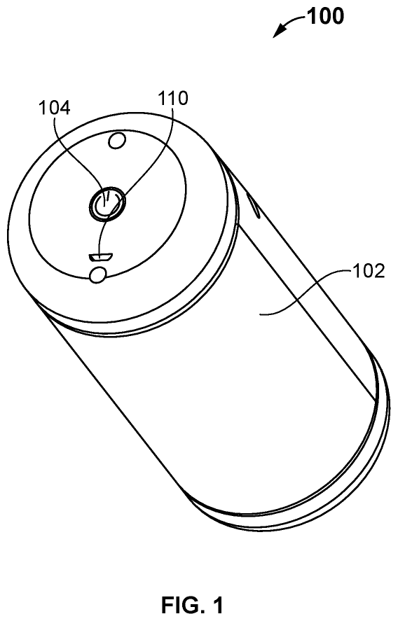

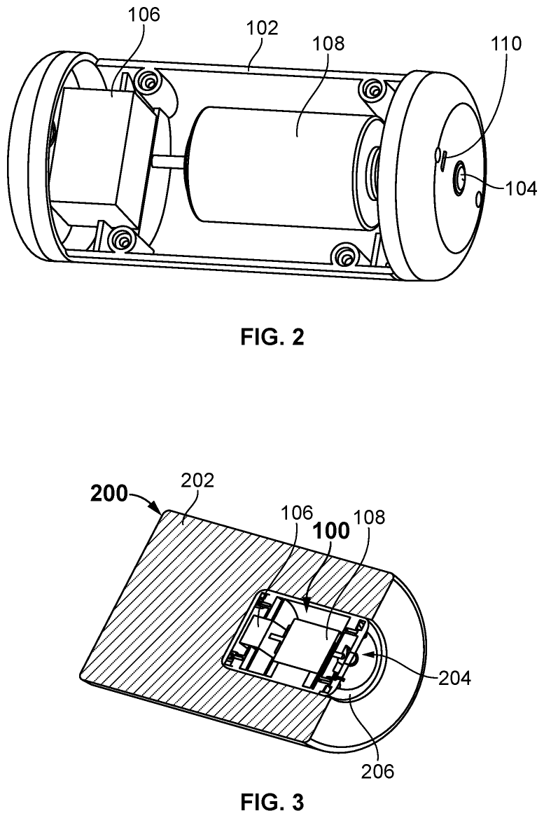

FIGS. 1-2 discloses a vibrator device 100 for massage assembly, according to an embodiment of the present invention. In one embodiment, the vibrator device 100 could be used with different massage as assembly. The massage assembly, includes, but not limited to, massage rollers, small massage rollers, foam balls, medium foam balls, lumbar and foot massagers, and peanut massage roller. The vibrator device 100 could be easily and conveniently setup with the different massage assemblies for effectively massaging any desired part of the user's body. The device 100 comprises a configuration and design that that provides simple and convenient installation steps to use with different massage devices and rollers. In one embodiment, the vibrator device 100 for a massage device or roller comprises a housing 102, at least one switch 104, at least one power source 106, at least one motor 108 with a shaft and an USB port 110. The shaft comprises one or more weights. In one embodiment, the housing 102 comprises at least two sections, which are removably affixed together using one or more fasteners.

In one embodiment, the user could turn on and turn off the vibrator device 100 using the switch 104. In one embodiment, the vibrator device 100 further comprises a level indicator to display the speed of the vibrator device and battery level of the power source for the user. The level indicator further displays the speed of the motor 108. In one embodiment, the motor 108 is configured to vibrate the massage assembly. In one embodiment, the motor 108 is electrically connected to the power source 106 via one or more conductive wires. In one embodiment, the power source 106 could be, but not limited to, a battery. In another embodiment, the power source 106 could be, but not limited to, a lithium polymer battery for providing power to the motor 108 for at least, but not limited to, 1 hour work time. In some embodiments, the vibrator device 100 for a massage device or roller comprises one or more power sources.

In one embodiment, the motor 108 is configured to operate at different speeds with respective to different frequencies. In one embodiment, the motor 108 could be operated at the speed of 3500 rpm at the frequency of about, but not limited to, 31 Hz. In another embodiment, the motor 108 could be operated at the speed of 4100 rpm at the frequency of about, but not limited to, 48 Hz. In yet another embodiment, the motor 108 could be operated at the speed of 4500 rpm at the frequency of about, but not limited to, 53 Hz. In yet another embodiment, the motor 108 could be operated at the speed of 4800 rpm at the frequency of about, but not limited to, 72 Hz.

In one embodiment, the vibrator device 100 is configured to provide strong vibration to the massage assembly, thereby providing effective and safe therapeutic massage experience for the user. In one embodiment, the user could recharge the power source 106, for example, a lithium polymer battery by connecting to a power supply using an adapter and a power cable or a USB cable via the USB port 110.

In one embodiment, at least one power source 106 is used for one or more low-cost massage rolling devices. The vibrator device 100 for a massage device is simple in design, durable, flexible or versatile, quick and easy to install in any shape of massage rolling devices, powers any shape of massage rolling devices, cost effective, and affordable for the user.

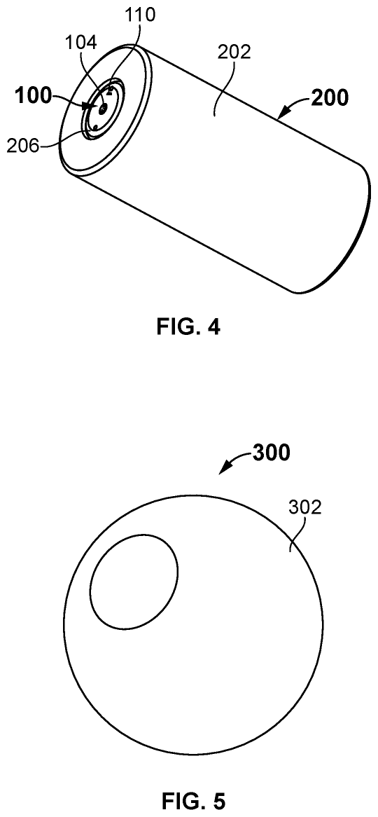

Referring to FIGS. 3-4, in one embodiment, the vibrator device 100 is securely positioned within a foam roller 200. In one embodiment, the foam roller 200 comprises a body 202 and a cavity 204 and an opening 206 that leads to the cavity 204. I one embodiment, the foam roller 200 is configured to securely receive the vibrator device 100 within the cavity 204. The user could simply position or insert the vibrator device 100 into the cavity 204 via the opening 206 of the foam roller 200. In one embodiment, the foam roller 200 is a small foam roller having a circular cross section. Thus, the present invention effectively uses the vibrator device 100 along with the foam roller 200 for massaging the user's body.

In one embodiment, the motor 108 powered by the power source 106 of the vibrator device 100 could effectively vibrate the foam roller 200 for providing therapeutic massage experience to the user. The foam roller 200 provided with the vibrator device 100 is configured to therapeutic advantages, alleviate pain, stimulate circulation, relieve tension, provide flexibility to muscles and joints, and also improve range of motion, and so forth.

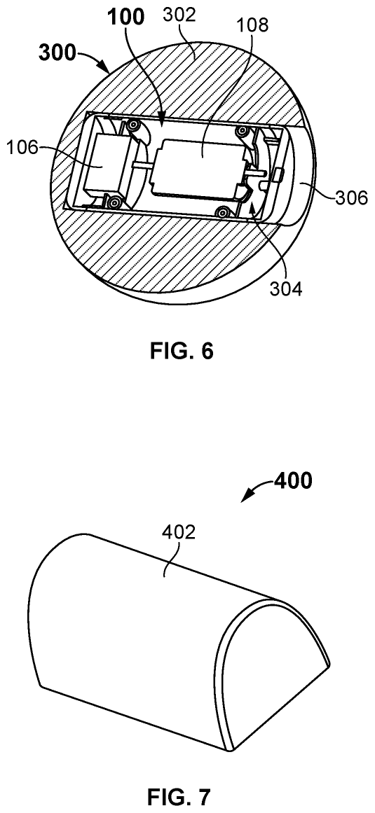

Referring to FIGS. 5-6, in another embodiment, the vibrator device 100 is securely positioned within a massage foam ball 300. In one embodiment, the vibrator device 100 is configured to securely position or insert within the foam ball 300. In one embodiment, the foam ball 300 comprises a body 302 and a cavity 304 at the center portion of the body 302. In one embodiment, the foam ball 300 is configured to securely receive the vibrator device 100 within the cavity 304. The foam ball 300 further comprises an opening 306 that provides access to the cavity 304. The user could position the vibrator device 100 within the cavity 304 via the opening 306. Thus, the present invention effectively uses the vibrator device 100 along with the foam roller 300 for massaging the user's body.

In one embodiment, the motor 108 powered by the power source 106 of the vibrator device 100 could effectively vibrate the foam ball 300 for providing therapeutic massage experience to the user. The foam ball 300 provided with the vibrator device 100 is configured to enhance therapeutic advantages, relax user's muscles, alleviate pain, stimulate circulation, relieve tension, provide flexibility to muscles and joints, and also improve range of motion, and so forth.

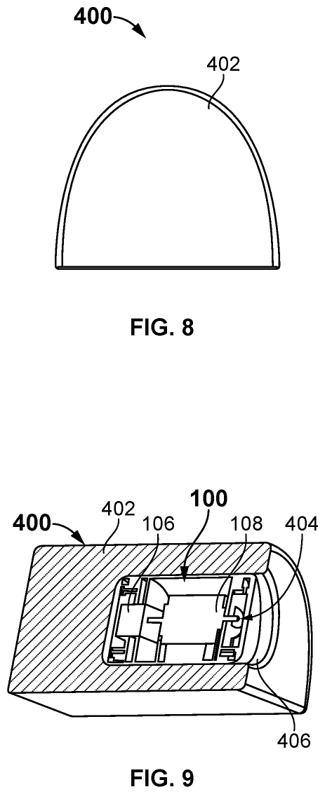

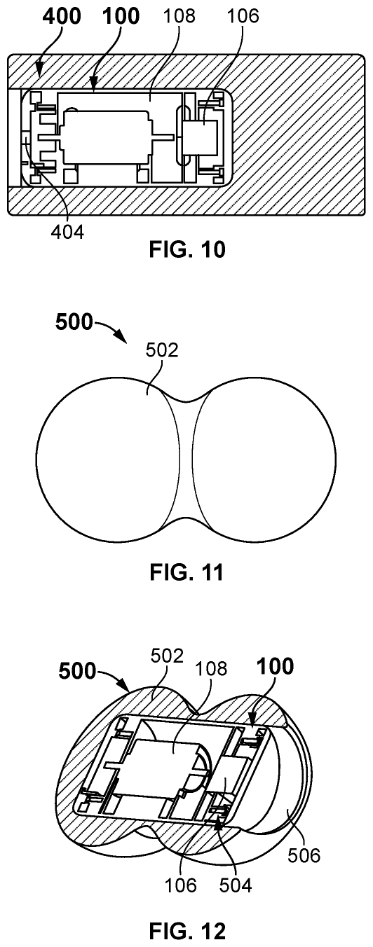

Referring to FIGS. 7-10, in yet another embodiment, the vibrator device 100 is securely positioned within a lumbar and foot foam massager 400. In one embodiment, the lumbar and foot foam massager 400 comprises a body 402 and a cavity 404 within the body 402. In one embodiment, the cavity 404 is formed at any portion of the body 402, for example, bottom portion of the body 402. The body 402 further comprises an opening 406 that allows to position the vibrator device 100 within the cavity 404. The user could simply position or insert the vibrator device 100 into the cavity 404 via the opening 406 of the lumbar and foot foam massager 400. Thus, the present invention effectively uses the vibrator device 100 along with the lumbar and foot foam massager 400 for massaging the user's body.

In one embodiment, the motor 108 powered by the power source 106 of the vibrator device 100 could effectively vibrate the lumbar and foot foam massager 400 for providing therapeutic massage experience to the user. The lumbar and foot foam massager 400 provided with the vibrator device 100 is configured to enhance therapeutic advantages, relax user's muscles, alleviate pain in the lumbar of the user, stimulate circulation, relieve tension, and provide flexibility to muscles and joints of the foot.

Referring to FIGS. 11-12, in yet another embodiment, the vibrator device 100 is securely positioned within a peanut foam massager or roller 500. In one embodiment, the peanut foam roller 500 comprises a body 502 and a cavity 504 within the body 502. In one embodiment, the cavity 504 is formed at any portion of the body 502, for example, bottom portion of the body 502. The body 502 further comprises an opening 506 that allows to position the vibrator device 100 within the body 502. The user could simply position or insert the vibrator device 100 into the cavity 504 via the opening 506 of the peanut foam roller 500. Thus, the present invention effectively uses the vibrator device 100 along with the peanut foam roller 500 for massaging the user's body.

In one embodiment, the motor 108 powered by the power source 106 of the vibrator device 100 could effectively vibrate the peanut foam roller 500 for providing therapeutic massage experience to the user. The peanut foam roller 500 provided with the vibrator device 100 is configured to enhance therapeutic advantages, relax user's muscles, alleviate pain in the lumbar of the user, stimulate circulation, relieve tension, provide flexibility to muscles and joints of the foot, and also improve range of motion, and so forth.

In one embodiment, the small foam roller 200, massage foam ball 300, lumbar and foot foam massager 400, and the peanut foam roller 500 are made of a material, but not limited to, expanded polypropylene (EPP), which is a highly versatile closed-cell bead foam that provides a unique range of properties, including outstanding energy absorption, multiple impact resistance, thermal insulation, buoyancy, water and chemical resistance, and exceptionally high strength to weight ratio and 100% recyclability. In one embodiment, the power source (battery, motor, output shaft and weights) are interchangeable from one foam shape to another foam shape. In an embodiment, the vibrator device 100 further comprises at least one of a handle, a knob, and a hook, which allows the user to remove the device 100 from the massage assembly. The massage assembly includes at least one of the small foam roller 200, the massage foam ball 300, the lumbar and foot foam massager 400, and the peanut foam roller 500. In one embodiment, the massage assembly includes a sleeve fixed inside the body of the foam. In an example, the sleeve is made of plastic material. In one example, the sleeve is fixed to the body (202, 302, 402, 502) by at least one of gluing method, or screwing method.

Advantageously, the prevent invention provides a single vibrating device 100 to operate various types of massage devices and rollers. Further, the present invention provides an economic, portable and versatile vibration device 100.

Preferred embodiments of this innovation are described herein, including the best mode known to the innovators for carrying out the innovation. It should be understood that the illustrated embodiments are exemplary only and should not be taken as limiting the scope of the innovation.

The foregoing description comprises illustrative embodiments of the present innovation. Having thus described exemplary embodiments of the present innovation, it should be noted by those skilled in the art that the within disclosures are exemplary only, and that various other alternatives, adaptations, and modifications may be made within the scope of the present innovation. Merely listing or numbering the steps of a method in a certain order does not constitute any limitation on the order of the steps of that method. Many modifications and other embodiments of the innovation will come to mind to one skilled in the art to which this innovation pertains having the benefit of the teachings in the foregoing descriptions. Although specific terms may be employed herein, they are used only in generic and descriptive sense and not for purposes of limitation. Accordingly, the present innovation is not limited to the specific embodiments illustrated herein.

What is claimed is:

1. A vibrator device for a massage assembly, comprising:
a housing;
at least one motor disposed in the housing and a shaft extending from the motor comprising one or more weights disposed within the housing, the motor is mechanically coupled to the massage assembly, the motor is configured to induce vibratory amplitude to vibrate the massage assembly, and
a power source positioned within the housing, the power source is electrically connected to power the motor.

2. The device of claim 1, further comprises at least one switch configured to enable a user to turn on and turn off the vibrator device.

3. The device of claim 1, wherein the housing comprises at least two sections, the two sections are joined together via one or more fasteners.

4. The device of claim 1, wherein the power source comprises a battery assembly having a lithium polymer battery.

5. The device of claim 1, further comprises a USB port configured to enable the user to recharge the battery assembly.

6. The device of claim 1, wherein the massage assembly includes at least one of a massage roller, a foam roller, a massage foam ball, a lumbar, a foot foam massager, and a peanut foam roller.

7. The device of claim 1, wherein the motor is configured to operate at different speeds with respective to different frequencies.

8. The device of claim 1, further comprises a level indicator configured to display a power level of the battery and a speed of the vibrator device.

9. A massage assembly, comprising:
a body having a cavity and an opening to access the cavity, and
a vibrator device received within the cavity and mechanically coupled to the massage assembly, the device comprises a housing having at least one motor, a shaft having one or more weights extends from the motor, and a power source electrically connected to the motor to supply power to the motor, the motor is configured to induce vibratory amplitude to vibrate the massage assembly.

10. The massage assembly of claim 9, wherein the vibratory device further comprises at least one switch configured to enable a user to turn on and turn off the vibrator device.

11. The massage assembly of claim 9, wherein the housing comprises at least two sections, the two sections are joined together via one or more fasteners.

12. The massage assembly of claim 9, wherein the power source comprises a battery assembly having a lithium polymer battery.

13. The massage assembly of claim 9, wherein the vibratory device further comprises a USB port configured to enable the user to recharge the battery assembly.

14. The massage assembly of claim 9, is at least one of a massage roller, a foam roller, a massage foam ball, a lumbar, a foot foam massager, and a peanut foam roller.

15. The massage assembly of claim 9, wherein the motor is configured to operate at different speeds with respective to different frequencies.

16. The massage assembly of claim 9, further comprises a level indicator configured to display a power level of the battery and a speed of the vibrator device.

17. The massage assembly of claim 9, wherein the body is made of foam material.

18. The massage assembly of claim 9, further comprises a sleeve fixed within the cavity, the sleeve is shaped to contour the shape of the cavity and receives the vibrating device therein.
